(19) United States
(12) Patent Application Publication
(10) Pub. No.: US 2009/0020624 A1
(43) Pub. Date: Jan. 22, 2009

(54) AIR-HEATING SYMBIOSITIC DRINKING FOUNTAIN APPARATUS

(76) Inventor: Shin-i Liu, Xin Cheng Village (TW)

Correspondence Address: RABIN & Berdo, PC, 1101 14TH STREET, NW, SUITE 500, WASHINGTON, DC, 20005, US

(21) Appl. No.: 11/780,563

(22) Filed: Jul. 20, 2007

(51) Int. Cl. B05B 12/14

(52) U.S. Cl. 239/28

(57) ABSTRACT

This invention discloses an air-heating symbiositic drinking fountain apparatus comprising: a drinking fountain, a spiral pipe, a motor and a gas exhaust pipe. The drinking fountain is installed in an automobile seat cabin, and the spiral pipe is installed in the gas exhaust pipe. The spiral pipe has a water outlet disposed at an end and connected to a water outlet position of the drinking fountain, and a water inlet disposed at another end and connected to a motor. The motor is connected to a connecting pipe and disposed between the water storage position of the drinking fountain and the motor. When the automobile is running, a high temperature is produced in the gas exhaust pipe, and the spiral pipe will be heated by the high temperature. When the water in the drinking fountain passes through the spiral pipe, the water is heated up for its use.

### BACKGROUND OF THE INVENTION

1. Field of the Invention

The present invention relates to an air-heating symbiositic drinking fountain apparatus, and more particularly to a drinking fountain capable of heating water without requiring external power supply, but the drinking fountain apparatus simply uses the heat energy produced by an exhaust pipe of a running automobile to heat water for its use.

2. Description of the Related Art

In general, an automobile usually does not come with a device of supplying hot water, so that if a driver or a passenger wants to have a cup of hot tea or hot drink while taking a long-distance or short-distance trip, the driver or passenger must drop by a store to buy the hot tea or hot drink or prepare one before taking off. When there is a baby in the automobile seat cabin and the baby needs to have milk, it will be difficult and inconvenient to make milk from milk powder for the baby without hot water.

Since the aforementioned apparatus must use an electric power system of the automobile and consume much power of the automobile, therefore the inventor of the present invention based on years of experience on the manufacture and design of the related industry to conduct extensive researches and experiments, and finally developed an air-heating symbiositic drinking fountain apparatus in accordance with the present invention.

### SUMMARY OF THE INVENTION

Therefore, it is a primary objective of the present invention to provide an air-heating symbiositic drinking fountain apparatus installed in an automobile, and the apparatus makes use of a high temperature of a gas exhaust pipe of a running car to heat water in the drinking fountain apparatus and supply hot water.

### BRIEF DESCRIPTION OF THE DRAWINGS

FIG. 1 is a schematic view of an application of the present invention.

Numerals used in the figure are listed below:
10 Drinking fountain
11 Water storage position
12 Water outlet position
13 Automobile chassis
20 Motor
21 Connecting pipe
30 Spiral pipe
31 Water inlet
32 Water outlet
40 Gas exhaust pipe

### DETAILED DESCRIPTION OF THE PREFERRED EMBODIMENTS

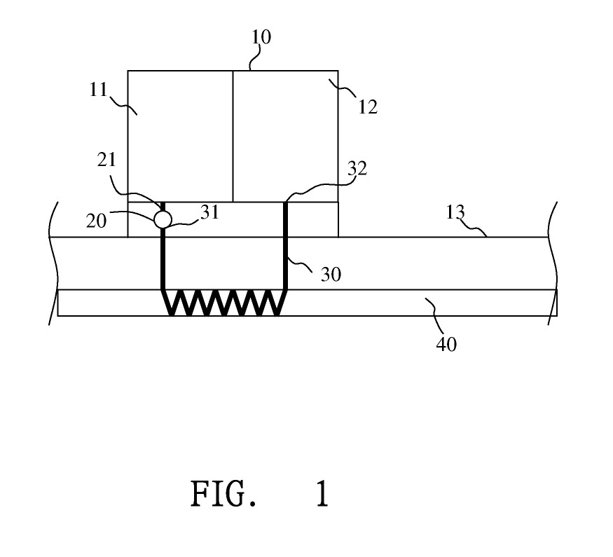

Referring to FIG. 1, the present invention comprises a drinking fountain 10, a motor 20, a spiral pipe 30 and a gas exhaust pipe 40.

The drinking fountain 10 is installed in an automobile seat cabin, and a connecting pipe 21 is connected at a water storage position 11 of the drinking fountain 10 and connected to a motor 20. The spiral pipe 30 is a tubular spiral object, installed in the gas exhaust pipe 40, wherein an end of the spiral pipe 30 is a water inlet 31 passing through the gas exhaust pipe 40 and an automobile chassis 13, and connected to the motor 20, and another end of the spiral pipe 30 is a water outlet 32 passing through the gas exhaust pipe 40 and the automobile chassis 13, and connected to a water outlet position 12 of the drinking fountain 10.

While the automobile is running, the gas exhaust pipe 40 produces a high temperature, and the spiral pipe 30 installed in the gas exhaust pipe 40 will be heated by the high temperature, such that when a user wants to use the drinking fountain 10, the user simply presses a button to start the motor 20 for pumping the water at the water storage position 11 of the drinking fountain 10, and the water will pass through the heated spiral pipe 30, and flow out from the water outlet position 12 of the drinking fountain 10 for its use.

What is claimed is:

1. An air-heating symbiositic drinking fountain apparatus, comprising:
a drinking fountain, including a water storage position and a water outlet position, and the drinking fountain being installed in an automobile seat cabin, and the water storage position being connected to a connecting pipe;
a motor, installed at the water storage position of the drinking fountain and connected to a connecting pipe which is connected to the water storage position for pressurizing water liquid;
a spiral pipe, being in a tubular spiral shape, with a water inlet at an end of the spiral pipe and a water outlet at another end of the spiral pipe, and the spiral pipe being installed in a gas exhaust pipe, and the water inlet is passed through the gas exhaust pipe, and the automobile chassis being connected to the motor, and the water outlet being passed through the gas exhaust pipe, and the automobile chassis being connected to a water outlet position of the drinking fountain; and
a gas exhaust pipe, having a spiral pipe installed therein, for discharging exhaust gas of an automobile;
thereby, the air-heating symbiositic drinking fountain apparatus achieves the effect of heating water in the drinking fountain by a high temperature produced by the gas exhaust pipe of a running automobile.
